(19) United States
(12) Patent Application Publication
(10) Pub. No.: US 2017/0134088 A1
(43) Pub. Date: May 11, 2017

(54) OPTICAL COMMUNICATION LINE MONITORING APPARATUS AND METHOD

(71) Applicant: SOLiD SYSTEMS, INC., Seongnam-si, Gyeonggi-do (KR)

(72) Inventor: Bum Soo PARK, Seongnam-si (KR)

(73) Assignee: SOLiD SYSTEMS, INC., Seongnam-si, Gyeonggi-do (KR)

(21) Appl. No.: 15/322,002

(22) PCT Filed: Jun. 27, 2014
(86) PCT No.: PCT/KR2014/005774

§ 371 Date: Dec. 23, 2016

(30) Foreign Application Priority Data
Jun. 27, 2014 (KR) 10-2014-0080212

(51) Int. Cl. H04B 10/071; H04B 10/079

(52) U.S. Cl. CPC H04B 10/071; H04B 10/0795

(57) ABSTRACT

Disclosed is an optical communication line monitoring apparatus comprising: an optical transceiver for transmitting management frames to remote devices connected to optical communication lines and receiving response frames transmitted from the remote devices; an optical time domain reflectometer (OTDR) for transmitting optical pulse signals to the optical communication lines and detecting reflection signals reflected from the optical communication lines, which have received the optical pulse signals; an optical switch for switching the optical transceiver and the OTDR at an input terminal thereof and switching each of multiple optical communication lines at an output terminal thereof; and a monitoring unit for determining whether or not a first optical communication line is abnormal based on a response frame transmitted from a first remote device, with the input terminal connected to the optical transceiver and the output terminal connected to the first optical communication line among the multiple optical communication lines.

### CROSS REFERENCE TO RELATED APPLICATIONS

This application is a National Stage of International Application No. PCT/KR2014/005774, filed Jun. 27, 2014, and claims priority from Korean Patent Applications No. 10-2014-0080212 filed Jun. 27, 2014, the contents of which are incorporated herein by reference in their entireties.

### BACKGROUND

1. Field

The present invention relates to an apparatus and a method of monitoring optical communication lines, and more particularly, to an apparatus and a method of monitoring optical communication lines by a polling method.

2. Description of Related Art

Optical communication is a communication method of transmitting and receiving information through optical fiber made of dual glazing using total reflection of laser beam. The optical communication does not interfere with external electromagnetic waves, is difficult to eavesdrop, and may process a large amount of information at the same time as compared with electric communication.

Various methods for monitoring the occurrence of an abnormality in an optical communication line have been used. FIG. 1 shows a method of monitoring an abnormality of an optical communication line 13 by using an optical time domain reflectometer (OTDR) 11.

A small amount of loss occurs due to Rayleigh scattering while light is transmitted through the optical communication line 13, and some of them are backscatter generated toward a light source. The OTDR 11 measures the backscattering power that is continuously reflected and measures a loss value generated on the optical communication line 13. However, the OTDR 11 can only measure the loss of one optical communication line 13 at a time. In order to measure another optical communication line, it is necessary to stop the communication through a currently used optical communication line 13 and connect the OTDR 11 to another optical communication line.

As another method of monitoring whether or not an optical communication line is abnormal, FIG. 2 shows a method of monitoring an abnormality of an optical communication line using a SuperVisory (SV) channel. The method of monitoring an abnormality of an optical communication line using the SV channel is based on the assumption that the SV channel is always connected to the optical communication line and there is a problem that a plurality of SVUs corresponding to SVUs located at respective remote locations must be located in a central office.

Therefore, there is a need for a method of effectively monitoring the occurrence of an abnormality of an optical communication line while overcoming the problems of the conventional art described above.

### SUMMARY

An apparatus and a method of monitoring optical communication lines according to an example embodiment of the present invention relate to effectively monitoring multiple optical communication lines with a small image area and low cost by combining an OTDR and an SVU through an optical switch.

Furthermore, an apparatus and a method of monitoring optical communication lines according to an example embodiment of the present invention relate to monitoring whether or not an optical communication line is abnormal without being directly input to a site by an administrator.

According to an example embodiment of the present invention, there is provided an optical communication line monitoring apparatus, including: an optical transceiver for transmitting management frames to remote devices connected to optical communication lines and receiving response frames transmitted from the remote devices; an optical time domain reflectometer (OTDR) for transmitting optical pulse signals to the optical communication lines and detecting reflection signals reflected from the optical communication lines, which have received the optical pulse signals; an optical switch for switching the optical transceiver and the OTDR at an input terminal thereof and switching each of multiple optical communication lines at an output terminal thereof; and a monitoring unit for determining whether or not a first optical communication line is abnormal based on a response frame transmitted from a first remote device, with the input terminal connected to the optical transceiver and the output terminal connected to the first optical communication line among the multiple optical communication lines.

The monitoring unit may measure the degree of loss in the first optical communication line based on a reflection signal reflected from the first optical communication line after connecting the input terminal of the optical switch with the OTDR when it is determined that an abnormality has occurred in the first optical communication line.

The optical switch may connect the output terminal to a second optical communication line instead of the first optical communication line when it is determined that no abnormality has occurred in the first optical communication line.

The monitoring unit may control a switching operation of the optical switch so that the output terminal of the optical switch is sequentially connected to each of the multiple optical communication lines at predetermined time intervals.

The monitoring unit may generate the management frames according to a fast ethernet protocol.

According to another example embodiment of the present invention, there is provided a method of monitoring optical communication lines, including: transmitting management frames to a first remote device connected to a first optical communication line using an optical transceiver when an input terminal of an optical switch is connected to the optical transceiver and an output of the optical switch is connected to the first optical communication line among multiple optical communication lines, wherein the optical switch switches the optical transceiver and an optical time domain reflectometer (OTDR) at the input terminal thereof and switches each of the multiple optical communication lines at the output terminal thereof; receiving a response frame transmitted from the first remote device through the optical transceiver; and determining whether or not the first optical communication line is abnormal based on the received response frame.

The method of monitoring optical communication lines may further include measuring the degree of loss in the first optical communication line based on a reflection signal reflected from the first optical communication line after connecting the input terminal of the optical switch with the OTDR when it is determined that an abnormality has occurred in the first optical communication line.

The method of monitoring optical communication lines may further include connecting the output terminal to a second optical communication line instead of the first optical communication line when it is determined that no abnormality has occurred in the first optical communication line.

The method of monitoring optical communication lines may further include controlling a switching operation of the optical switch so that the output terminal of the optical switch is sequentially connected to each of the multiple optical communication lines at predetermined time intervals.

The method of monitoring optical communication lines may further include generating the management frames according to a fast ethernet protocol.

An apparatus and a method of monitoring optical communication lines according to an example embodiment of the present invention may effectively monitor multiple optical communication lines with a small image area and low cost by combining an OTDR and an SVU through an optical switch.

Furthermore, an apparatus and a method of monitoring optical communication lines according to an example embodiment of the present invention may monitor whether or not an optical communication line is abnormal without being directly input to a site by an administrator.

### BRIEF DESCRIPTION OF THE FIGURES

Example embodiments of the present invention will be more clearly understood from the following detailed description taken in conjunction with the accompanying drawings in which:

FIG. 1 is a view illustrating a method of monitoring an abnormality of an optical communication line using a general optical time domain reflectometer (OTDR).

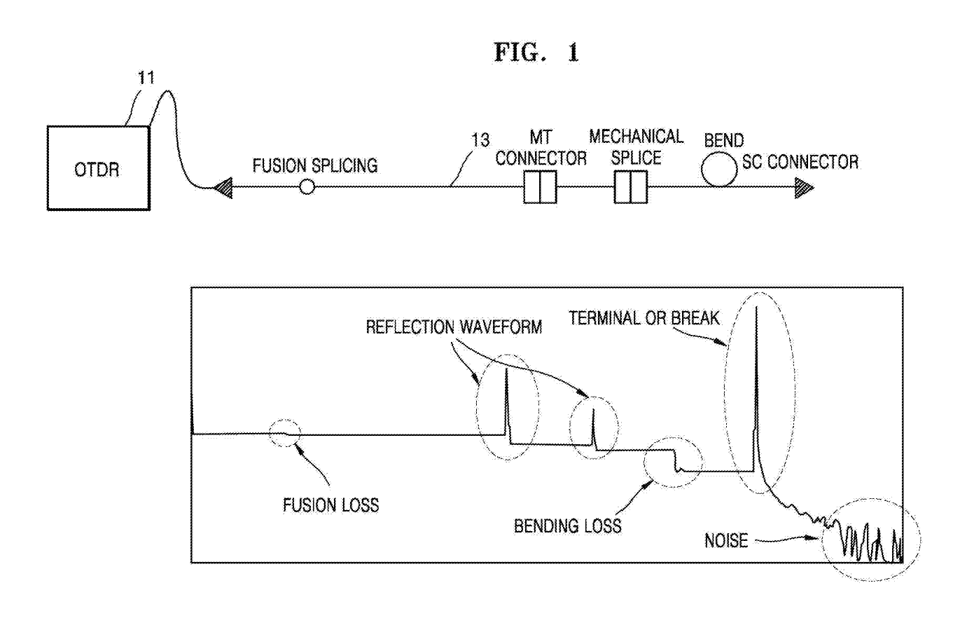

FIG. 2 is a view illustrating a method of monitoring an abnormality of an optical communication line using a general SuperVisory (SV) channel.

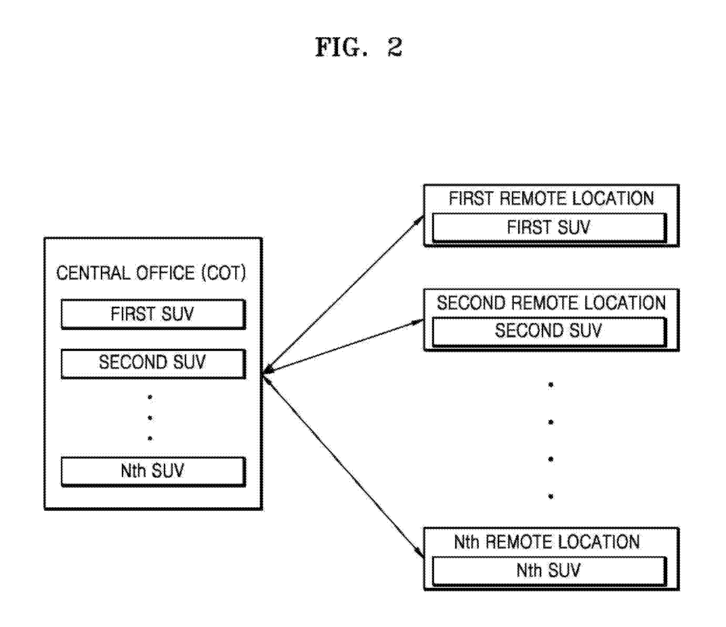

FIG. 3 is a view illustrating a configuration of an optical communication line monitoring apparatus according to an example embodiment of the present invention.

FIG. 4 is a view illustrating a procedure of a method of monitoring optical communication lines according to another example embodiment of the present invention.

### DETAILED DESCRIPTION OF EXEMPLARY EMBODIMENTS

Since the present invention may have diverse modified embodiments, preferred embodiments are illustrated in the drawings and are described in the detailed description. However, this does not limit the present invention within specific embodiments and it should be understood that the present invention covers all the modifications, equivalents, and replacements within the idea and technical scope of the present invention.

In the description of the present invention, certain detailed explanations of the related art are omitted when it is deemed that they may unnecessarily obscure the essence of the present invention. In addition, numeral figures (for example, 1, 2, and the like) used during describing the specification are just identification symbols for distinguishing one element from another element.

Further, in the specification, if it is described that one component is “connected” or “accesses” the other component, it is understood that the one component may be directly connected to or may directly access the other component but unless explicitly described to the contrary, another component may be “connected” or “access” between the components.

In addition, terms such as “ . . . unit”, “ . . . module”, or the like refer to units that perform at least one function or operation, and the units may be implemented as hardware or software or as a combination of hardware and software.

Furthermore, components of the specification are divided in accordance with a main function of each component. That is, two or more components to be described below may be provided to be combined to one component or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

Hereinafter, example embodiments of the present invention will be described in detail.

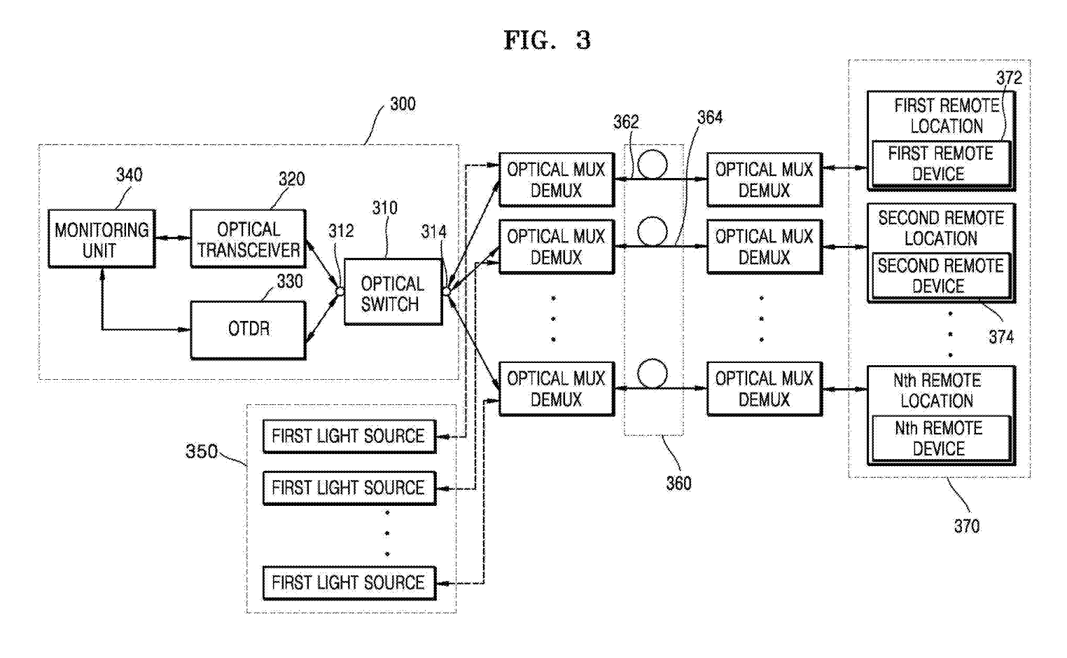

FIG. 3 is a view illustrating a configuration of an optical communication line monitoring apparatus 300 according to an example embodiment of the present invention.

In a configuration for optical communication, each of multiple optical communication lines 360 is connected to a light source 350 corresponding to each of the multiple optical communication lines 360. Each of the multiple optical communication lines 360 may be connected to a remote location 370 corresponding to each of the optical communication lines 360. The light source 350 may provide an optical signal for a mobile communication service, and the multiple optical communication lines 360 may provide a communication path for an optical signal transmitted from the light source 350. The remote location 370 may receive optical signals transmitted from each of the multiple optical communication lines 360.

An optical multiplexer/demultiplexer may be connected to both ends of each of the multiple optical communication lines 360. The optical multiplexer/demultiplexer may multiplex an optical signal or demultiplex the multiplexed optical signal.

Referring to FIG. 3, the optical line monitoring apparatus 300 according to an example embodiment of the present invention may include an optical switch 310, an optical transceiver 320, an OTDR 330, and a monitoring unit 340.

The optical switch 310, which is a 2×N type switch, may switch the optical transceiver 320 and the OTDR 330 at an input terminal 312 thereof and switch each of the multiple optical communication lines 360 at an output terminal 314 thereof. In more detail, the input terminal 312 of the optical switch 310 may be selectively connected to the optical transceiver 320 or the OTDR 330 and the output terminal 314 of the optical switch 310 may be connected to any one of the multiple optical communication lines 360.

The optical transceiver 320 may transmit the management frame to a remote device connected to an optical communication line through the optical communication line and receive a response frame transmitted from the remote device. The optical transceiver 320 may transmit the response frame to the monitoring unit 340.

The OTDR 330 may transmit an optical pulse signal to an optical communication line and detect a reflection signal reflected from the optical communication line.

The monitoring unit 340 may control the optical transceiver 320, the OTDR 330, and the optical switch 310 to determine whether or not an abnormality has occurred in each of the multiple optical communication lines 360.

The monitoring unit 340 may generate a management frame for monitoring optical communication lines. The monitoring unit 340 may generate the management frame according to a predetermined communication protocol, and the predetermined communication protocol may include, for example, a fast ethernet protocol. The monitoring unit 340 may use a physical layer and medium access control layer standards as a basic transmission protocol.

The monitoring unit 340 may control the optical switch 310 so that the input terminal 312 of the optical switch 310 is connected to the optical transceiver 320 and the output terminal 314 of the optical switch 310 may be connected to any one (for example, a first optical communication line 362) of the multiple optical communication lines 360. The monitoring unit 340 may transmit a management frame to the optical transceiver 320 so that the management frame is transmitted to a first remote device 372 connected to the first optical communication line 362 by the optical transceiver 320.

When the first remote device 372 transmits a response frame to the optical transceiver 320 in response to the management frame, the optical transceiver 320 transfers the response frame to the monitoring unit 340. The monitoring unit 340 may determine whether the first optical communication line 362 is abnormal based on loss information of the response frame, received optical power, and the like.

When it is determined that no abnormality has occurred in the first optical communication line 362 based on the response frame transmitted from the first remote device 372, the monitoring unit 340 may connect the output terminal 314 of the optical switch 310 to another optical communication line (for example, a second optical communication line 364) instead of the first optical communication line 362 to monitor whether or not an abnormality has occurred in another optical communication line. In other words, when it is determined that no abnormality has occurred in any of the multiple optical communication lines 360, the monitoring unit 340 may control a switching operation of the output terminal 314 of the optical switch 310, and thus, may automatically determine whether or not all of the optical communication lines 360 are abnormal. To this end, the monitoring unit 340 may control a switching operation of the optical switch 310 so that the output terminal 314 of the optical switch 310 is sequentially connected to each of the multiple optical communication lines 360 at predetermined time intervals. For example, the monitoring unit 340 sequentially connects the output terminal 314 thereof to first through nth optical communication lines for a predetermined time interval to automatically monitor whether or not an abnormality has occurred in the first through nth optical communication lines.

When it is determined that an abnormality has occurred in the first optical communication line 362 based on the response frame transmitted from the first remote device 372, the monitoring unit 340 may stop switching of the output terminal 314 of the optical switch 310 and may connect the input terminal 312 of the optical switch 310 to the OTDR 330 to measure the degree of loss in the first optical communication line 362. When the input terminal 312 of the optical switch 310 is connected to the OTDR 330, the OTDR 330 may transmit an optical pulse signal to the first optical communication line 362 and may detect a reflection signal reflected from the first optical communication line 362. The monitoring unit 340 may measure the degree of loss in the first optical communication line 362 based on the reflection signal reflected from the first optical communication line 362. The monitoring unit 340 may measure the degree of loss in the first optical communication line 362 and specify the position where the abnormality has occurred in the first optical communication line 362. The monitoring unit 340 may transmit information indicating that an abnormality has occurred in the first optical communication line 362 and information indicating the position where the abnormality has occurred in the first optical communication line 362 to an administrator terminal.

When the loss of the first optical communication line 362 is measured, the monitoring unit 340 may connect the input terminal 312 of the optical switch 310 to the optical transceiver 320 and the output terminal 314 of the optical switch 310 to the second optical communication line 364. In addition, the monitoring unit 340 may determine whether the second optical communication line 364 is abnormal based on a response frame transmitted from a second remote device 374 connected to the second optical communication line 364.

Since the optical communication line monitoring apparatus 300 according to an example embodiment of the present invention performs both monitoring using the OTDR 330 and monitoring using the SV channel by using the optical switch 310, it is possible to monitor an abnormality of an optical communication line more effectively than a general monitoring method.

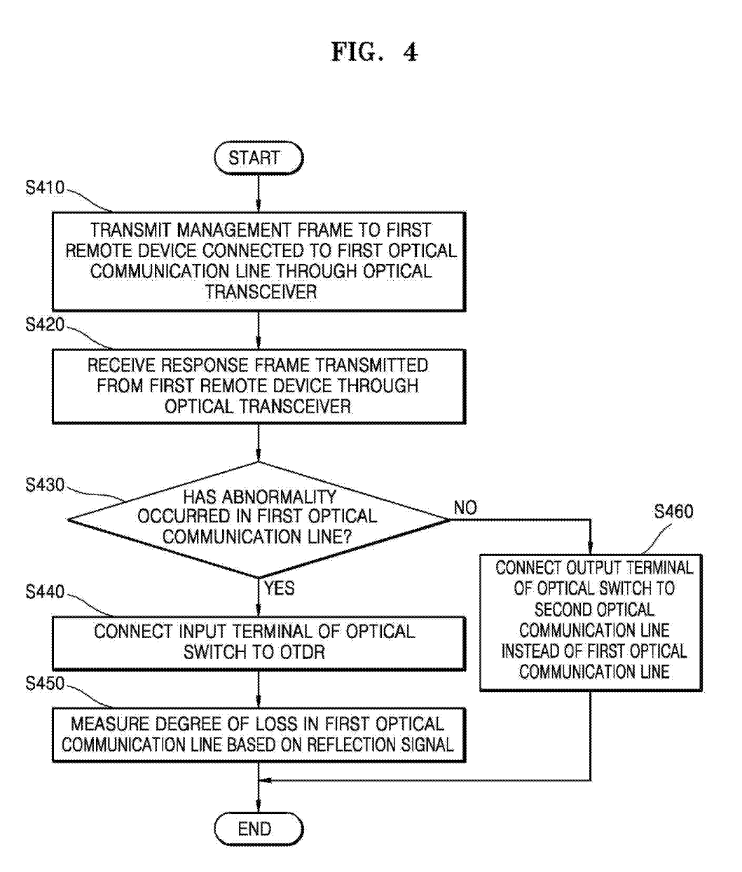

FIG. 4 is a view illustrating a procedure of a method of monitoring optical communication lines according to another example embodiment of the present invention. Referring to FIG. 4, the method of monitoring optical communication lines according to another example embodiment of the present invention includes operations of time series processing in the optical communication line monitoring apparatus 300 of FIG. 3. Therefore, even if the descriptions are omitted below, it will be understood that the contents described above with respect to the optical communication line monitoring apparatus 300 of FIG. 3 are also applied to the method of monitoring optical communication lines of FIG. 4.

In operation S410, the monitoring unit 340 transmits a management frame to the first remote device 372 connected to the first optical communication line 362 through the optical transceiver 320 and the first optical communication line 362 when the optical transceiver 320 and the OTDR 330 are switched at the input terminal 312, the input terminal 312 of the optical switch 310 for switching each of the multiple optical communication lines 360 at the output terminal 314 is connected to the optical transceiver 320, and the output terminal 314 is connected to the first optical communication line 362 from among the multiple optical communication lines 360. The monitoring unit 340 may generate a management frame according to a predetermined communication protocol, and the predetermined communication protocol may include a fast ethernet communication protocol.

In operation S420, the monitoring unit 340 receives a response frame transmitted from the first remote device 372 through the optical transceiver 320. The first remote device 372 may generate a response frame in accordance with a predetermined communication protocol and transmit it to the optical transceiver 320 via the first optical communication line 362.

In operation S430, the monitoring unit 340 determines whether an abnormality has occurred in the first optical communication line 362 based on the response frame. The monitoring unit 340 may determine whether the first optical communication line 362 is abnormal based on loss information of the response frame, received optical power, and the like. A method of determining whether an optical communication line is abnormal based on a response frame in an SV channel is obvious to those of ordinary skilled in the art, and a detailed description thereof will not be given herein.

In operation S440, the monitoring unit 340 connects the input terminal 312 of the optical switch 310 to the OTDR 330 when it is determined that an abnormality has occurred in the first optical communication line 362. The input terminal 312 of the optical switch 310 is connected to the OTDR 330 so that the OTDR 330 and the first optical communication line 362 are connected to each other and the connection between the optical transceiver 320 and the first optical communication line 362 will be blocked.

In operation S450, the monitoring unit 340 measures the degree of loss in the first optical communication line 362 based on a reflection signal reflected from the first optical communication line 362 in response to an optical pulse signal transmitted from the OTDR 330 to the first optical communication line 362. The monitoring unit 340 may transmit information indicating that an abnormality has occurred in the first optical communication line 362 and information indicating the position where the abnormality has occurred in the first optical communication line 362 to an administrator terminal.

In operation S460, when it is determined that no abnormality has occurred in the first optical communication line 362 based on the response frame transmitted from the first remote device 372, the monitoring unit 340 may connect the output terminal 314 of the optical switch 310 to the second optical communication line 364 instead of the first optical communication line 362 to determine whether or not an abnormality has occurred in the second optical communication line 364.

The monitoring unit 340 may sequentially connect the output terminal 314 of the optical switch 310 to each of the multiple optical communication lines 360 at predetermined time intervals. The connection order for each of the multiple optical communication lines 360 may be preset.

The example embodiments of the present invention can be written as computer programs and can be implemented in general-use digital computers that execute the programs using a computer readable recording medium.

The computer readable recording medium may be a magnetic storage medium (e.g., a ROM, a floppy disk, a hard disk, etc.), an optical reading medium (e.g., a CD ROM, a DVD or the like), and a carrier wave (e.g., transmission over the Internet).

While the present invention has been particularly shown and described with reference to embodiments thereof, it will be understood that various changes in form and details may be made therein without departing from the spirit and scope of the following claims.

1. An optical communication line monitoring apparatus comprising:
an optical transceiver for transmitting management frames to remote devices connected to optical communication lines and receiving response frames transmitted from the remote devices;
an optical time domain reflectometer (OTDR) for transmitting optical pulse signals to the optical communication lines and detecting reflection signals reflected from the optical communication lines, which have received the optical pulse signals;
an optical switch for switching the optical transceiver and the OTDR at an input terminal thereof and switching each of multiple optical communication lines at an output terminal thereof; and
a monitoring unit for determining whether or not a first optical communication line is abnormal based on a response frame transmitted from a first remote device, with the input terminal connected to the optical transceiver and the output terminal connected to the first optical communication line among the multiple optical communication lines.

2. The optical communication line monitoring apparatus of claim 1, wherein
the monitoring unit measures the degree of loss in the first optical communication line based on a reflection signal reflected from the first optical communication line after connecting the input terminal of the optical switch with the OTDR when it is determined that an abnormality has occurred in the first optical communication line.

3. The optical communication line monitoring apparatus of claim 1, wherein,
the optical switch connects the output terminal to a second optical communication line instead of the first optical communication line when it is determined that no abnormality has occurred in the first optical communication line.

4. The optical communication line monitoring apparatus of claim 1, wherein
the monitoring unit controls a switching operation of the optical switch so that the output terminal of the optical switch is sequentially connected to each of the multiple optical communication lines at predetermined time intervals.

5. The optical communication line monitoring apparatus of claim 1, wherein
the monitoring unit generates the management frames according to a fast ethernet protocol.

6. A method of monitoring optical communication lines, the method comprising:
transmitting management frames to a first remote device connected to a first optical communication line using an optical transceiver when an input terminal of an optical switch is connected to the optical transceiver and an output of the optical switch is connected to the first optical communication line among multiple optical communication lines, wherein the optical switch switches the optical transceiver and an optical time domain reflectometer (OTDR) at the input terminal thereof and switches each of the multiple optical communication lines at the output terminal thereof;
receiving a response frame transmitted from the first remote device through the optical transceiver; and
determining whether or not the first optical communication line is abnormal based on the received response frame.

7. The method of claim 6, further comprising:
measuring the degree of loss in the first optical communication line based on a reflection signal reflected from the first optical communication line after connecting the input terminal of the optical switch with the OTDR when it is determined that an abnormality has occurred in the first optical communication line.

8. The method of claim 6, further comprising:
connecting the output terminal to a second optical communication line instead of the first optical communication line when it is determined that no abnormality has occurred in the first optical communication line.

9. The method of claim 6, further comprising:
controlling a switching operation of the optical switch so that the output terminal of the optical switch is sequentially connected to each of the multiple optical communication lines at predetermined time intervals.

10. The method of claim 6, further comprising:
generating the management frames according to a fast ethernet protocol.
